(19) United States
(12) Patent Application Publication
(10) Pub. No.: US 2009/0309320 A1
(43) Pub. Date: Dec. 17, 2009

(54) Ski equipped with a collapsible undercarriage device

(76) Inventor: GADI LIBERMAN, Ashkelon (IL)

Correspondence Address: Mr Gadi Liberman, 33 Yiftah Giladi Street, Ashkelon, 78492, omitted

(21) Appl. No.: 12/482,522

(22) Filed: Jun. 11, 2009

Related U.S. Application Data
(60) Provisional application No. 61/073,048, filed on Jun. 17, 2008.

(51) Int. Cl. B62B 13/18; A63C 5/06

(52) U.S. Cl. 280/9; 280/601

(57) ABSTRACT

A ski equipped with a collapsible undercarriage device including: a ski, an undercarriage carrier and a collapsible undercarriage device, wherein the collapsible undercarriage device has wheels upon arms which can be folded and deployed, enabling safe skiing when the arms are folded and carrying the ski upon the ground, which can be snowed, with assistance of the wheels, when the arms are deployed and with another ski optionally connected to it.

### CROSS-REFERENCE TO RELATED APPLICATIONS

This application claims the benefit under 35 U.S.C. §119(e) of U.S. Provisional Patent Application No. 61/073,048 filed Jun. 17, 2008, the content of which is incorporated herein.

### FIELD OF THE INVENTION

The present invention generally relates to the field of skiing. More particularly, the present invention relates to a Ski equipped with a collapsible undercarriage device for easy transportation.

Ski has become a popular sport, which appeals to many social echelons of the developed world. By nature, skiing usually takes place on high, snow-capped mountains, on which the temperatures are very low, and requires suitably warm clothing, protective glasses against frost and the blinding light reflected by the snow, thick gloves or mittens to protect the hands from the cold and from injury, and boots designed especially to connect firmly to the skis but primarily to protect the legs from injury during falls.

In many ski sites around the world, skiers must walk long distances to access ski slopes. For the walk, they have to carry their heavy skis by hand or on their shoulders. Often, such groups of skiers can be seen trudging along for hundreds of meters, and while carrying their heavy gear, the skis often separate from each other and “escape” to the sides. Small items such as hats or gloves often fall, and the heavy skis then need to be put down in order to pick up the fallen item. Small children tagging along behind an instructor without an adult to provide personal assistance particularly suffer from this, when they are required to handle the heavy load by themselves.

A possible solution to reduce the effort required to carry the skis is to divide the weight load of the skis between the skier's body and the ground by adding a couple of wheels or a mini-ski at the end of the pair of skis.

Parker describes the use of a ski equipment carrier comprising a wheel component, which clamps onto the skis and has two wheels for rolling the skis, and a handle component, in U.S. Pat. No. 5,340,153 (1994), whose disclosures are incorporated herein by reference.

FIG. 1 of the prior art is a schematic side view illustration of a ski carrier 50 temporarily carrying two skis 100, which are supported on one end by the hand of a person. A major disadvantage of this kind of solution is the need to unpack the skis from the equipment carrier and find a temporary storage solution for the equipment carrier or rather for the skier to carry it while skiing. Both options are problematic.

There is thus a widely recognized need for, and it would be highly advantageous to have, a device that enables reducing the load of carrying skis without having any significant effect on the pleasure and performance of the skier.

The prior art does not teach or suggest such a device.

### SUMMARY OF THE INVENTION

The solution according to the present invention to the problem described above is providing a compact collapsible undercarriage device which can be assembled to a standard ski, thus rendering a ski equipped with a collapsible undercarriage device and also skis originally manufactured as a ski equipped with a collapsible undercarriage device. This solution enables carrying the skis with their weight carried partially by the ground, and afterwards folding the device and using the skis for skiing, with the device carried on one of the skis.

According to a first embodiment, of the present invention, an undercarriage carrier, is connected to the top surface of one of a pair of skis, in a manner that is not necessarily suitable for quick assembly and release, to and from which the collapsible undercarriage device can be easily assembled and released. Namely, it is possible to ski with the collapsible undercarriage device connected to the ski, and the skis can be stored with it, but it does not prevent them from being conveniently and easily separated.

According to a second embodiment, of the present invention, the collapsible undercarriage device is connected directly to one of a pair of skis.

The collapsible undercarriage device includes a pair of wheels, mini-skis, or a combination of both, each carried on an arm.

The arm has two modes, a closed mode suitable for skiing, and an open mode suitable for carrying. Opening and deploying the arms with the wheels can be done with the assistance of elastic devices. In both of these modes, the arms are locked with arm locks.

Carrying the pair of skis is done with the ski equipped with a collapsible undercarriage device turned facing downwards to the ground, namely, the bottom surface of the ski faces upward, and the other ski is fastened to it by means of one or more elastic bands. The rear part of the second ski (which does not need to be equipped with a collapsible undercarriage device) can be connected to a small handle, by means of which the skis can be easily carried/pulled. An elastic band can also be added near this handle to strengthen the grip between both skis. This elastic band is stretched around the ski that is equipped with a collapsible undercarriage device, achieving a single unit that will not come apart during carrying/transport of the skis.

### BRIEF DESCRIPTION OF THE DRAWINGS

The invention is herein described, by way of example only, with reference to the accompanying drawings, wherein:

FIG. 1 of the prior art illustrates a ski carrier temporarily carrying two skis, which are supported by a person's hand on one side.

FIG. 2 is a perspective view schematic illustration of the first exemplary embodiment of a ski equipped with a collapsible undercarriage device, according to the present invention.

FIG. 3 is a perspective view schematic illustration of the first exemplary embodiment of an undercarriage carrier and a collapsible undercarriage device, according to the present invention, in which they are separated from each other and the collapsible undercarriage device is in closed mode.

FIG. 4 is a perspective view schematic illustration of the first exemplary embodiment of the undercarriage carrier and the collapsible undercarriage device, according to the present invention, in which they are connected to each other and the collapsible undercarriage device is in closed mode.

FIG. 5 is a perspective view schematic illustration of the first exemplary embodiment of the undercarriage carrier and the collapsible undercarriage device, according to the present invention, in which they are connected to each other and the collapsible undercarriage device is in opened mode, and upon which the section plane a-a is marked.

FIG. 6 is a front view schematic illustration of the first exemplary embodiment of the undercarriage carrier and the collapsible undercarriage device, according to the present invention, in which they are connected to each other and the collapsible undercarriage device is in opened mode.

FIG. 7 is a cross sectional view a-a schematic illustration of the first exemplary embodiment of the elastic device, according to the present invention.

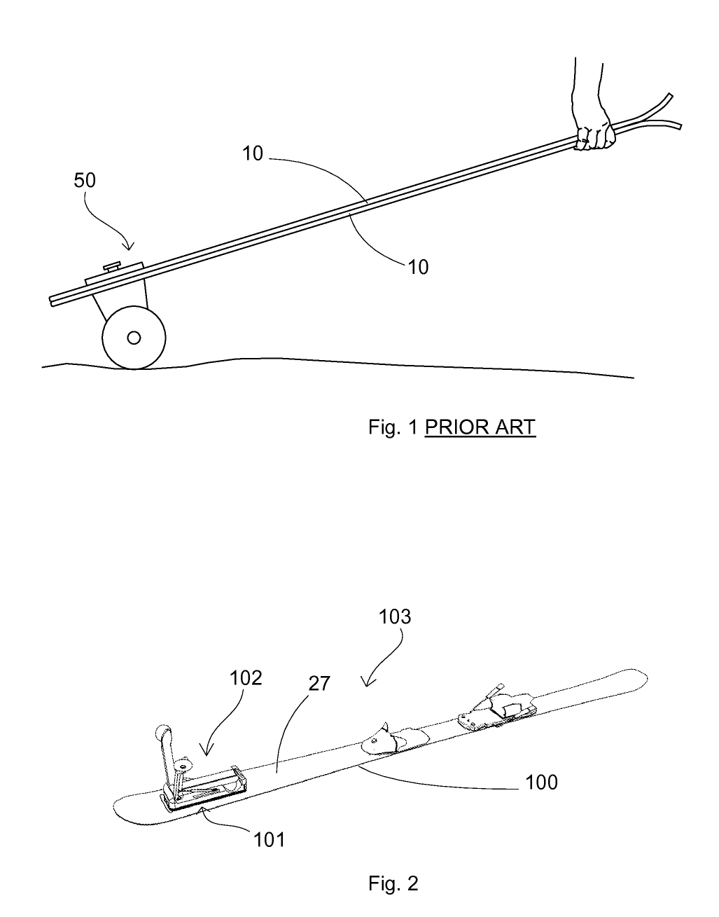

### DETAILED DESCRIPTION OF EMBODIMENTS

The present invention is a ski carrying device and, in particular a ski equipped with a collapsible undercarriage device.

The principles and operation of a ski equipped with a collapsible undercarriage device according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawings.

Unless otherwise defined, all technical and scientific terms used herein have the same meaning as commonly understood by one of ordinary skill in the art to which this invention belongs. The materials, dimensions, methods, and examples provided herein are illustrative only and are not intended to be limiting.

Before explaining at least one embodiment of the invention in detail, it is to be understood that the invention is not limited in its application to the details of construction and the arrangement of the components set forth in the following description or illustrated in the drawing. The invention is capable of other embodiments or of being practiced or carried out in various ways. Also, it is to be understood that the phraseology and terminology employed herein is for the purpose of description and should not be regarded as limiting.

The following is a list of legend of the numbering of the application illustrations:

12 undercarriage carrier lock

13 undercarriage carrier lock release button

14 elastic band

15 collapsible undercarriage body

16 arm

17 elastic device

18 wheel

19 arm lock release button

20 arm lock

22 elastic device outer tube

23 elastic device inner tube

24 spring

25 arm pivot

26 wheel pivot

27 ski upper surface

31 rail

32 guide track

50 ski carrier (prior art)

100 ski

101 undercarriage carrier

102 collapsible undercarriage device

103 ski equipped with a collapsible undercarriage device

Referring now to the drawings, FIG. 2 is a perspective view schematic illustration of the first exemplary embodiment of a ski equipped with a collapsible undercarriage device 103, according to the present invention. The ski equipped with a collapsible undercarriage device 103 includes three main assemblies: a ski 100, which can be a standard ski, which is connected to the ski upper surface 27 by means of screws, adhesive, Velcro, or any other suitable means, and an undercarriage carrier 101. This connection is not necessarily suitable for quick assembly and disassembly.

It is even possible that the ski 100 is manufacture with the undercarriage carrier 101 as an integral part. The undercarriage carrier 101 should be assembled as close as possible to the front of the ski 100.

The collapsible undercarriage device 102 is assembled to an undercarriage carrier 101. Assembly and disassembly of the collapsible undercarriage device 102 to and from the undercarriage carrier 101 can be done quickly and easily, due to their mechanical structures, as will be described in the following.

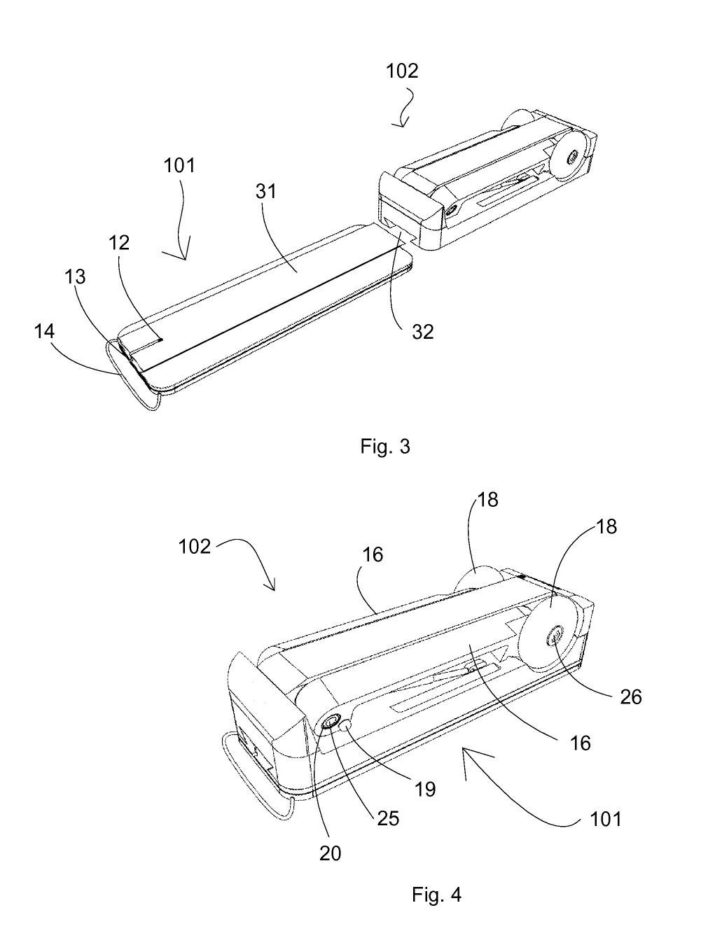

FIG. 3 is a perspective view schematic illustration of the first exemplary embodiment of the undercarriage carrier 101 and the collapsible undercarriage device 102, according to the present invention, in which they are separated from each other and the collapsible undercarriage device 102 is in closed mode.

The undercarriage carrier 101 includes a lengthwise rail 31, with an undercarriage carrier lock 12 and undercarriage carrier lock release button 13 disposed at its front part, and also an elastic band 14 which serves for the connection of both skis to each other.

The collapsible undercarriage device 102 also includes guide track 32 which fits to rail 31 in shape and dimensions. Connection of the collapsible undercarriage device 102 to the undercarriage carrier 101 is achieved by lengthwise sliding upon rail 31 with the cross sections of rail 31 and guide track 32 ensuring that separation along the lateral plane between the collapsible undercarriage device 102 and the undercarriage carrier 101 is impossible. They are also locked by means of undercarriage carrier lock 12, which makes ‘non voluntary’ longitudinal separation impossible as well.

In order to separate the collapsible undercarriage device 102 from the undercarriage carrier 101, undercarriage carrier lock release button 13 needs to be pressed.

Note: for the purpose of the present patent application, longitudinal movement is defined as movement approximately along the ski's longitudinal axis, while the lateral plane is defined as a plane perpendicular to the ski's longitudinal axis.

The structural materials of the collapsible undercarriage device 102 and the undercarriage carrier 101 should have qualities that ensure a high strength to weight ratio, such as rigid plastic materials, suitable metals, and silicon, with optional combination of several different structural materials.

The dimensions of the collapsible undercarriage device 102 and the undercarriage carrier 101 can vary greatly to comply to the size of any ski.

The dimensions of the collapsible undercarriage device 102 and the undercarriage carrier 101 can vary greatly to comply to the size of any ski.

FIG. 4 is a perspective view schematic illustration of the first exemplary embodiment of the undercarriage carrier 101 and the collapsible undercarriage device 102, according to the present invention, in which they are connected to each other and the collapsible undercarriage device 102 is in closed mode.

Each arm 16 is connected to the collapsible undercarriage device 102 by means of an arm pivot 25 which grants the arm rotational movement.

The arms 16, at the end of each of which is wheel 18, are in their folded mode, and they remain locked in this mode by means of arm locks 20.

Arm lock release button 19 may conceal the arm pivot 25.

Each wheel 18 is connected to an arm 16 by means of a wheel pivot 26 which grants the wheel rotational movement.

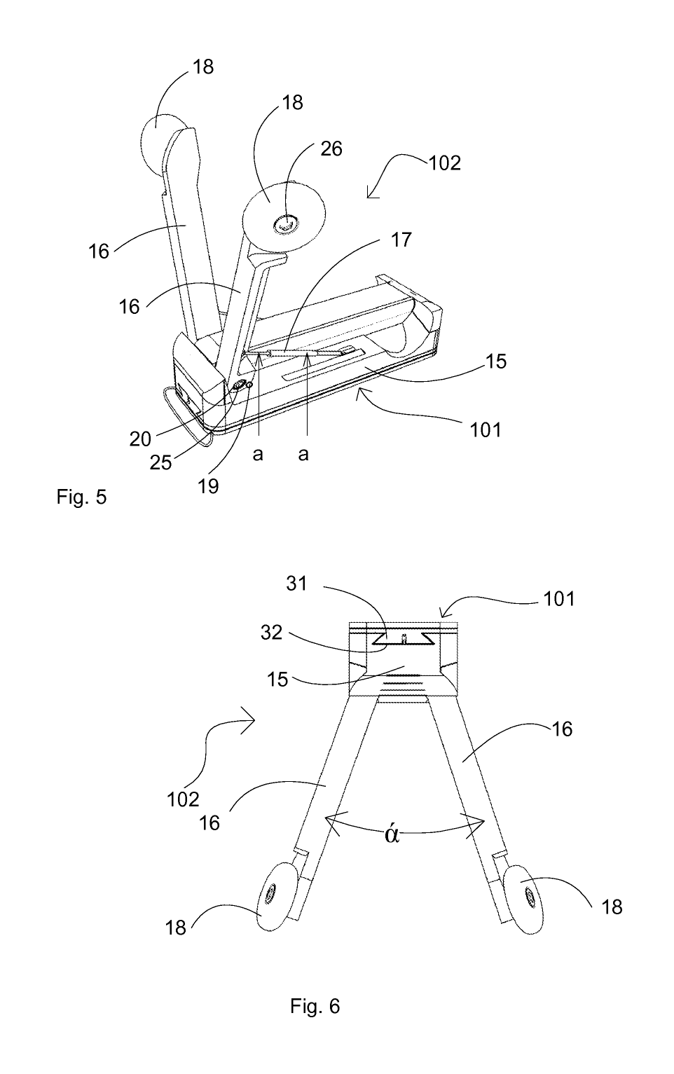

FIG. 5 is a perspective view schematic illustration of the first exemplary embodiment of the undercarriage carrier 101 and the collapsible undercarriage device 102, according to the present invention, upon which the section plane a-a is marked, in which they are connected to each other and the collapsible undercarriage device 102 is in open mode.

The arms 16, at the end of each of which is wheel 18, are in their open mode after forces have been applied to them by elastic devices 17 connected between them and the collapsible undercarriage body 15, each by means of two pivots, and they remain locked in this by means of arm locks 20.

Releasing the lock can be achieved by pressing arm lock release button 19 which can be disposed at the end of the arm pivot 25, and even conceal it.

Arm lock release button 19, according to the first exemplary embodiment, releases both arm locks 20 with a single press.

According to the another exemplary embodiment, the collapsible undercarriage device 102, includes two lock release buttons 19, and pressing each one separately releases each one of both arm locks 20.

FIG. 6 is a front view schematic illustration of the first exemplary embodiment of the undercarriage carrier 101 and the collapsible undercarriage device 102, according to the present invention, in which they are connected to each other and the collapsible undercarriage device 102 is in open mode.

Rail 31 is engaged with guide track 32. Both of the arms 16 can be at an opening angle of a to each other, so the distance between both wheels 18 increases, granting lateral stability.

According to another embodiment, at the end of each arm 16 is a mini-ski, from which a wheel 18 protrudes (similar to landing gear of aircraft designated for landing in the snow), so the skis can be pulled and carried upon either solid ground or snow).

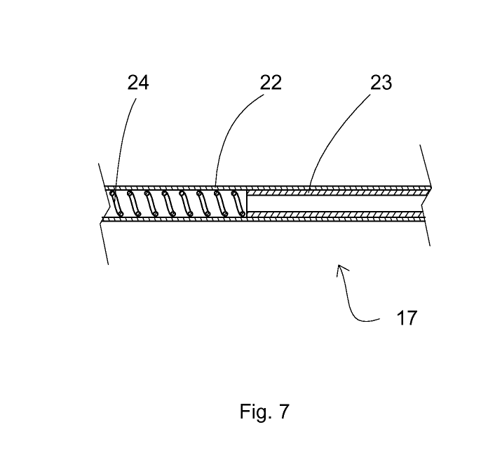

FIG. 7 is a cross sectional view a-a schematic illustration of the first exemplary embodiment of the elastic device 17, according to the present invention.

The elastic device 17 of the first exemplary embodiment is composed of two tubes which are compatible to each other in size and shape, and whose lateral cross sections can be circular or of other geometrical shapes.

The elastic device inner tube 23 can move lengthwise within the elastic device outer tube 22. Within the elastic device outer tube 22, there is disposed a spring 24 which is designated to assist in going from closed mode, which is suitable for skiing, to open mode, which is suitable for carrying after deployment of arm (16) with wheel (18).

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A ski equipped with a collapsible undercarriage device comprising:
(a) a ski, having an upper surface;
(b) an undercarriage carrier disposed on said upper surface, said undercarriage carrier including:
(i) a rail, wherein said rail has predetermined shape and dimensions; and
(c) a collapsible undercarriage device including:
(i) a collapsible undercarriage body; and
(ii) a guide track at said collapsible undercarriage body, wherein said guide track has predetermined shape and dimensions, wherein said guide track's shape and dimensions are compatible with said rail's shape and dimensions, wherein said collapsible undercarriage device is mounted on said undercarriage carrier, and wherein a skier can safely skidding with said ski equipped with a collapsible undercarriage device.

2. The ski equipped with a collapsible undercarriage device of claim 1, wherein said undercarriage carrier further includes:
(ii) an undercarriage carrier lock, for locking said collapsible undercarriage device to said undercarriage carrier, said undercarriage carrier lock mounted on said undercarriage device; and
(iii) an undercarriage carrier lock release button for enabling the release of said collapsible undercarriage device from said undercarriage carrier, said undercarriage carrier lock release button mounted on said undercarriage device.

3. The ski equipped with a collapsible undercarriage device of claim 1, wherein said collapsible undercarriage device further includes:
(iii) at least one arm pivot disposed on said collapsible undercarriage device;
(iv) an arm mounted on said arm pivot;
(iii) a wheel pivot disposed on said arm; and
(vi) a wheel mounted on said wheel pivot.

4. The ski equipped with a collapsible undercarriage device of claim 3, wherein said collapsible undercarriage device further includes:
(vii) an elastic device having a first end and a second end, wherein said first end is mounted on said arm and wherein said second end is mounted on said collapsible undercarriage body.
